(19) United States
(12) Patent Application Publication
(10) Pub. No.: US 2008/0193831 A1
(43) Pub. Date: Aug. 14, 2008

(54) ANODE ACTIVE MATERIAL, METHOD OF PREPARING THE SAME, ANODE AND LITHIUM BATTERY CONTAINING THE MATERIAL

(75) Inventors: Sang-kook Mah, Seoul (KR); Han-su Kim, Seoul (KR)

Correspondence Address: CHRISTIE, PARKER & HALE, LLP, PO BOX 7068, PASADENA, CA, 91109-7068, US

(73) Assignee: SAMSUNG SDI CO., LTD., Suwon-si (KR)

(21) Appl. No.: 11/861,200

(22) Filed: Sep. 25, 2007

(30) Foreign Application Priority Data
Feb. 14, 2007 (KR) 10-2007-0015527

(51) Int. Cl. H01M 4/48; C01B 33/113

(52) U.S. Cl. 429/122; 423/325; 252/182.1; 977/742

(57) ABSTRACT

Silicon oxide based anode active materials are provided. In one embodiment, the active materials include silicon oxides represented by the general formula SiOₓ, where 0<x<0.8. The anode active materials include silicon oxides having low oxygen contents. Further, anodes and lithium batteries employing such anode active materials have excellent charge-discharge characteristics.

### CROSS-REFERENCE TO RELATED PATENT APPLICATION

This application claims priority to and the benefit of Korean Patent Application No. 10-2007-0015527, filed on Feb. 14, 2007 in the Korean Intellectual Property Office, the entire content of which is incorporated herein by reference.

### BACKGROUND OF THE INVENTION

1. Field of the Invention

The present invention relates to anode active materials, methods of preparing the same, and anodes and lithium batteries containing the anode active materials. More particularly, the invention is directed to anode active materials including silicon oxides having low oxygen contents.

2. Description of the Related Art

In an effort to achieve high voltages and energy densities, research and development has been extensively conducted into non-aqueous electrolyte secondary batteries using lithium compounds as anodes. Specifically, metallic lithium has become the subject of intense research due to its ability to impart high initial battery capacity. Accordingly, lithium has gained great attention as a prominent anode material. However, when metallic lithium is used as an anode material, large amounts of lithium are deposited on the surface of the anode in the form of dendrites, which may degrade charge and discharge efficiencies or cause internal-shorts between the anode and the cathode. Further, lithium is very sensitive to heat or impact and is prone to explosion due to its instability, i.e., high reactivity, which has held up commercialization. In order to eliminate these problems with the use of metallic lithium, carbonaceous materials have been proposed for use as anode materials. Carbonaceous anodes perform redox reactions such that lithium ions in the electrolytic solution intercalate/deintercalate in the carbonaceous material which has a crystal lattice structure during charge and discharge cycles. These anodes are referred to as “rocking chair type” anodes.

The carbonaceous anode has made a great contribution to the widespread use of lithium batteries by overcoming various disadvantages associated with metallic lithium. However, electronic equipment are becoming smaller and more lightweight, and the use of portable electronic instruments is becoming more widespread, making the development of lithium secondary batteries having higher capacities a major focal point. Lithium batteries using carbonaceous anodes have low battery capacity because of the porosity of the carbonaceous anode. For example, graphite (which is an ultra-high crystalline material), when used in a LiC₆ structure (made by reaction of graphite with lithium ions), has a theoretical capacity density of about 372 mAh/g. This is only about 10% that of metallic lithium, i.e., 3860 mAh/g. Thus, in spite of many problems with conventional metallic anodes, studies for improving battery capacity using metallic lithium as the anode material are actively being carried out.

A representative example of such studies is the use of materials that can alloy with lithium, e.g., Si, Sn, Al, or the like, as anode active materials. However, materials that can alloy with lithium, such as Si or Sn, may present several problems, including volumetric expansion during formation of the lithium alloy, creation of electrically disconnected active materials in an electrode, aggravation of electrolytic decomposition due to increases in surface area, and so on.

In order to overcome these problems with the use of such a metallic material, a technique of using a metal oxide exhibiting a relatively low volumetric expansion as an anode active material has been proposed. For example, use of an amorphous Sn-based oxide has been proposed which minimizes the Sn particle size and prevents agglomeration of Sn particles during charge and discharge cycles, thereby leading to improvement of capacity retention characteristics. However, Sn-based oxides unavoidably cause reactions between lithium and oxygen atoms, which is responsible for considerable irreversible capacities.

High capacity electrodes using silicon oxides as the anode materials for secondary lithium ion batteries have also been proposed. However, irreversible capacities are considerably large during initial charge-discharge cycling stages, giving the secondary lithium ion batteries undesirable cycling characteristics and preventing practical use.

### SUMMARY OF THE INVENTION

In one embodiment of the present invention, a silicon oxide based composite anode active material includes a silicon oxide having low oxygen content.

In another embodiment of the present invention, an anode includes the anode active material. In yet another embodiment, a lithium battery includes the anode active material, and the battery exhibits improved charge and discharge capacity and capacity retention.

In another embodiment of the present invention, a method of preparing the anode active material is provided.

According to an embodiment of the present invention, a silicon oxide based composite anode active material includes a silicon oxide represented by the general formula SiOₓ, where 0<x<0.8.

According to another embodiment of the present invention, an anode comprises the anode active material. In another embodiment, a lithium battery includes the anode active material.

According to another embodiment of the present invention, a method of preparing a silicon oxide based composite anode active material includes preparing a silicon oxide precursor by reacting a silane compound represented by Formula 1 with lithium, and sintering the silicon oxide precursor in an inert atmosphere at a temperature ranging from about 400 to about 1300° C.

SiXₙY₄₋ₙ Formula 1

In Formula 1, n is an integer ranging from 2 to 4, X is a halogen atom, and Y is selected from hydrogen atoms, phenyl groups and C₁₋₁₀ alkoxy groups.

Unlike conventional silicon oxide based composite anode active materials (which are derived from silicon dioxide, silicon monoxide, or the like), the anode active materials of the present invention are composite anode active materials including silicon oxides having low oxygen content. In addition, anodes and lithium batteries including the composite anode active materials of the present invention have excellent charge and discharge characteristics.

### BRIEF DESCRIPTION OF THE DRAWINGS

The above and other features and advantages of the present invention will become more apparent by reference to the following detailed description when considered in conjunction with the attached drawings in which:

FIG. 1A depicts the results of an energy dispersive spectrometer (EDS) measurement of the silicon oxide prepared in Comparative Example 3;

FIG. 1B depicts the results of an EDS measurement of the silicon oxide prepared in Example 1;

FIG. 2 depicts the X-ray diffraction patterns of the silicon oxide (SiOₓ) prepared according to Example 1 and the silicon oxide (SiO) prepared according to Comparative Example 3;

FIG. 3 depicts the Raman spectrum of the silicon oxide (SiOₓ) prepared according to Example 1;

FIG. 4 is a graph comparing the capacity retention after numerous charge/discharge cycles of the lithium batteries prepared according to Example 9 and Comparative Examples 8 and 9;

FIG. 5 is a graph comparing the capacity after numerous charge/discharge cycles of lithium batteries prepared according to Examples 10 through 12 and Comparative Example 10; and

FIG. 6 is a cross-sectional view of a lithium battery according to one embodiment of the present invention.

### DETAILED DESCRIPTION OF THE INVENTION

The present invention will now be described with reference to the accompanying drawings, in which exemplary embodiments of the invention are shown. However, various modifications and changes may be made to the described embodiments, and the invention is not limited to the described embodiments.

A silicon oxide based anode active material according to an embodiment of the present invention includes a silicon oxide represented by the general formula SiOₓ where 0<x<0.8. In one embodiment of the silicon oxide, 0<x<0.5. In another embodiment, 0<x<0.3.

According to an embodiment of the present invention, the silicon oxide has a high silicon content, with a mole ratio of silicon to oxygen of more than 1 mole of silicon per 0.8 mole of oxygen. This enables increases in electrical capacity, and is a marked improvement over conventional silicon oxides, which have mole ratios of silicon to oxygen of less than 1 mole of silicon per 1 mole of oxygen. Also, the silicon-to-oxygen bonds in the silicon oxides according to the present invention function as supports against the shrinkage/expansion of silicon atoms, thus preventing electrical disconnections due to the shrinkage/expansion of silicon atoms and imparting improved cycle life characteristics.

When the silicon oxide forms a composite with a carbonaceous material, or the like, the composite can have uniform carbon distribution since the silicon oxide is reacted in a liquid or gas phase.

In one embodiment, the silicon oxide based composite anode active material may further include a metal capable of alloying with lithium, a metal oxide capable of alloying with lithium, or carbon. The metal or metal oxide capable of alloying with lithium may be selected from Si, SiOₓ (where 0.8<x≦2), Sn, SnOₓ (where 0<x≦2), Ge, GeOₓ (where 0<x≦2), Pb, PbOₓ (where 0<x≦2), Ag, Mg, Zn, ZnOₓ (where 0<x≦2), Ga, In, Sb, Bi, and alloys thereof. The carbon may be selected from graphite, carbon black, carbon nanotubes (CNT), and mixtures thereof.

In another embodiment, the silicon oxide based composite anode active material may further include a carbonaceous coating layer on the silicon oxide. Alternatively, the silicon oxide may be a complex of silicon oxide and a carbonaceous material. The carbonaceous coating layer binds the silicon oxide particles to form a composite of the silicon oxide and the carbon, and can function as a path for electrons and ions, thereby improving battery efficiency and capacity.

According to another embodiment of the present invention, an anode employs the anode active material. More particularly, an anode employs the silicon oxide based composite anode active material described above.

In one embodiment, the anode is prepared by mixing the silicon oxide based composite anode active material and a binder to form an anode material and shaping the anode material. Alternatively, the anode material may be applied on a current collector such as copper foil.

More specifically, an anode composition may be prepared and then coated directly on a copper foil current collector. Alternatively, the anode composition is cast on a separate support body to form a film, which film is then stripped from the support body and laminated on the copper foil current collector to obtain an anode plate. The anodes of the present invention are not limited to these examples and many other modifications may be made without departing from the scope of the invention.

Large amounts of current are required to charge and discharge higher capacity batteries. Thus, to obtain high capacity batteries, low resistance materials are used as the electrode materials. In order to reduce the resistance of the electrode, a variety of conducting materials may be employed. Nonlimiting examples of suitable conducting materials include carbon black and graphite fine particles.

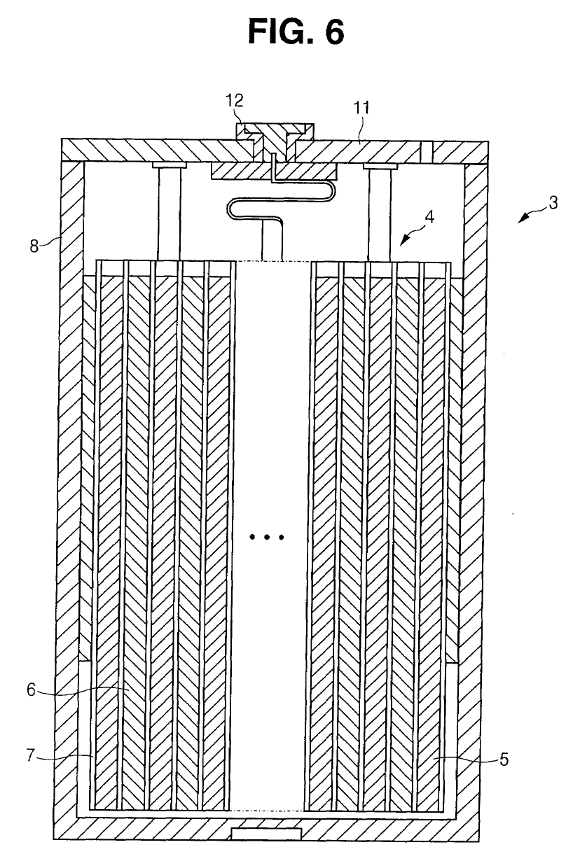

In another embodiment of the present invention, a lithium battery includes the anode. As shown in FIG. 6, a lithium battery 3 includes an electrode assembly 4 including a cathode 5, anode 6 and a separator 7 positioned between the cathode 5 and anode 6. The electrode assembly 4 is housed in a battery case 8, and sealed with a cap plate 11 and sealing gasket 12. An electrolyte is then injected into the battery case to complete the battery. A lithium battery according to one embodiment of the present invention is prepared in the following manner.

First, a cathode active material, a conducting agent, a binder, and a solvent are mixed to prepare a cathode active material composition. The cathode active material composition is coated directly on a metallic current collector and dried to prepare a cathode. In an alternative embodiment, the cathode active material composition is cast on a separate support body to form a cathode active material film, which film is then peeled from the support body and laminated on the metallic current collector.

Any lithium-containing metal oxide commonly used in the art may be used as the cathode active material. Nonlimiting examples of suitable lithium-containing metal oxides include LiCoO₂, LiMnₓO₂ₓ, LiNiₓ₋₁MnₓO₂ₓ (where x=1, 2), Li_{1-x-y}CoₓMn_{y}O₂ (where 0≦x≦0.5, 0≦y≦0.5). Specific, nonlimiting examples of suitable lithium-containing metal oxides include compounds capable of oxidizing and reducing lithium ions, such as LiMn₂O₄, LiCoO₂, LiNiO₂, LiFeO₂, V₂O₅, TiS, MoS, and the like. One nonlimiting example of a suitable conducting agent is carbon black. Nonlimiting examples of suitable binders include vinylidene fluoride/hexafluoropropylene (HFP) copolymers, polyvinylidene difluoride (PVDF), polyacrylonitrile, polymethylmethacrylate, polytetrafluoroethylene, and mixtures thereof. Styrene butadiene rubber polymers may also be used as the binder. Nonlimiting examples of suitable solvents include N-methyl-pyrrolidone, acetone, water, and the like. The amounts of the cathode electrode active material, the conducting agent, the binder, and the solvent used in the manufacture of the lithium battery are amounts generally acceptable in the art.

Any separator that is commonly used for lithium batteries can be used. In particular, the separator may have low resistance to the migration of ions in an electrolyte and have excellent electrolyte-retaining abilities. Nonlimiting examples of suitable separators include woven and non-woven fabrics of glass fibers, polyester, Teflon, polyethylene, polypropylene, polytetrafluoroethylene (PTFE), and combinations thereof. In particular, windable separators including polyethylene, polypropylene or the like can be used in lithium ion batteries. Separators that can retain large amounts of organic electrolytic solution may be used in lithium-ion polymer batteries. A method of forming a separator will now be described.

A polymer resin, a filler and a solvent are mixed to prepare a separator composition. The separator composition is coated directly on the electrode, and then dried to form a separator film. Alternatively, the separator composition can be cast onto a separate support and dried to form a film, which film is then detached from the separate support and laminated on an electrode, thereby forming a separator film.

Any polymer resin commonly used for binding electrode plates in lithium batteries can be used without limitation. Nonlimiting examples of suitable polymer resins include vinylidenefluoride/hexafluoropropylene copolymers, polyvinylidenefluoride, polyacrylonitrile, polymethylmethacrylate, and mixtures thereof.

The electrolyte may include a lithium salt dissolved in the electrolyte solvent. Nonlimiting examples of suitable electrolyte solvents include propylene carbonate, ethylene carbonate, diethyl carbonate, ethylmethyl carbonate, methylpropyl carbonate, butylene carbonate, benzonitrile, acetonitrile, tetrahydrofuran, 2-methyltetrahydrofuran, gamma-butyrolactone, dioxolane, 4-methyld ioxolane, N,N-dimethyl formamide, dimethyl acetamide, dimethylsulfoxide, dioxane, 1,2-dimethoxyethane, sulfolane, dichloroethane, chlorobenzene, nitrobenzene, dimethyl carbonate, methylethyl carbonate, diethyl carbonate, methylpropyl carbonate, methylisopropyl carbonate, ethylpropyl carbonate, dipropyl carbonate, dibutyl carbonate, diethylene glycol, dimethyl ether, and mixtures thereof. Nonlimiting examples of suitable lithium salts include LiPF₆, LiBF₄, LiSbF₆, LiAsF₆, LiClO₄, LiCF₃SO₃, Li(CF₃SO₂)₂N, LiC₄F₉SO₃, LiSbF₆, LiAl O₄, LiAlCl₄, LiN(CₓF₂ₓ₊₁SO₂)(C_{y}F_{2y+1}SO₂) (where each of x and y is a natural number), LiCl, Lil, and mixtures thereof.

The separator is positioned between the cathode electrode and the anode electrode to form the electrode assembly. The electrode assembly is wound or folded and then sealed in a cylindrical or rectangular battery case. Then, the electrolyte solution is injected into the battery case to complete preparation of a lithium ion battery.

Alternatively, a plurality of electrode assemblies may be stacked in a bi-cell structure and impregnated with an organic electrolyte solution. The resultant product is put into a pouch and hermetically sealed, thereby completing a lithium ion polymer battery.

According to another embodiment of the present invention, a method of preparing a composite anode active material includes preparing a silicon oxide precursor by reacting a silane compound represented by Formula 1 with lithium, and sintering the silicon oxide precursor in an inert atmosphere at a temperature ranging from about 400 to about 1300° C.

SiXₙY₄₋ₙ Formula 1

In Formula 1, n is an integer of 2 to 4, X is a halogen atom, and Y is selected from hydrogen atoms, phenyl groups, and C₁₋₁₀ alkoxy groups.

The silicon oxide precursor may be prepared by gas phase reduction of a silane compound instead of reacting the silane compound with lithium. Any gas phase reduction commonly used in the art can be used.

When sintering of the silicon oxide precursor is performed at temperatures lower than about 400° C., electrode characteristics may degrade due to unreacted SiOH. On the other hand, when sintering is performed at temperatures greater than about 1300° C., electrode capacity may decrease since SiC is formed.

In one embodiment, the sintering temperature may range from about 900 to about 1300° C.

According to one embodiment, the silicon oxide can be prepared through one of Reaction Schemes 1 through 4 below.

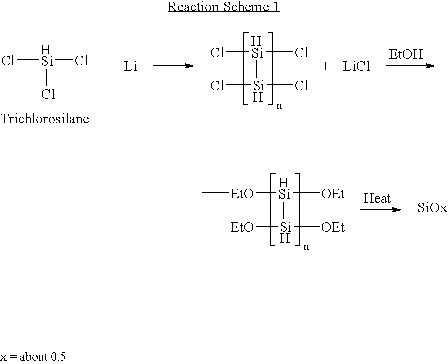

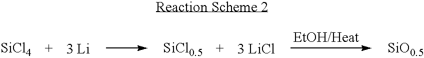

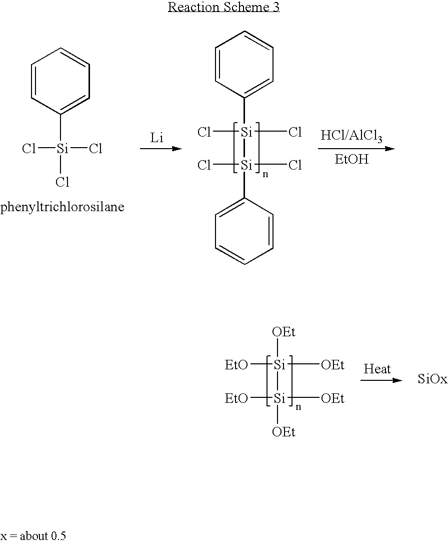

In sintering the silicon oxide precursor, from about 3 to about 90 wt % of carbonaceous material or a carbon precursor (based on a total weight of the mixture of the silicon oxide precursor and the carbonaceous material or carbon precursor) may be added to the silicon oxide precursor. When the amount of the carbonaceous material or carbon precursor is less than about 3 wt %, electric conductivity may decrease. On the other hand, when the amount of the carbonaceous material or carbon precursor is greater than about 90 wt %, capacity may decrease.

Nonlimiting examples of suitable the carbonaceous materials include graphite, carbon black, carbon nanotubes, and mixtures thereof.

Nonlimiting examples of suitable carbon precursors include pitch, furfuryl alcohol, glucose, sucrose, phenol resins, phenol oligomers, resorcinol resins, resorcinol oligomers, phloroglucinol resins, and phloroglucinol oligomers.

In sintering the silicon oxide precursor, a metal or metal oxide capable of alloying with lithium may be added to the silicon oxide precursor. Nonlimiting examples of the metal or metal oxide capable of alloying with lithium include Si, SiOₓ (where 0.8<x≦2), Sn, SnOₓ (where 0<x≦2), Ge, GeOₓ (where 0<x≦2), Pb, PbOₓ (where 0<x≦2), Ag, Mg, Zn, ZnOₓ (where 0<x≦2), Ga, In, Sb, Bi, and alloys thereof.

The silicon oxide precursor may include an oxygen atom.

A method according to one embodiment of the present invention may further include re-sintering a mixture of the sintered silicon oxide precursor and a carbon precursor after sintering the silicon oxide precursor.

The anode active materials of the present invention are easily prepared from silane compounds, and the oxygen content in the silicon oxide can be easily controlled by controlling synthesis conditions such as the mole ratio of the silane compound to lithium. Accordingly, in the silicon oxide represented by the general formula SiOₓ, x can be easily controlled to be within 0<x<0.8.

The present invention will now be described with reference to the following examples. These examples are presented for illustrative purposes only and are not intended to limit the scope of the present invention.

### PREPARATION OF SILICON OXIDE

### Example 1

A 1.05 g piece of a 0.53 mm thick Li film and 30 ml of tetrahydrofuran (THF) were added to a 100 ml flask and mixed. The mixture was then placed in an ice bath. Then, 5 cc of trichlorosilane (HSiCl₃, Aldrich) was added to the flask and the mixture was reacted for 24 hours. 10 ml of ethanol was slowly added to the mixture and reacted for 3 hours. The resulting product was filtered using a 0.5 μm filter, washed sequentially with ethanol, distilled water and acetone, and dried in an oven at 60° C. to obtain a partially oxidized silicon oxide precursor. The silicon oxide precursor was heat-treated at 900° C. in a nitrogen atmosphere to obtain a silicon oxide.

### Example 2

0.2 g of the silicon oxide precursor prepared according to Example 1 and 0.08 g of pitch were mixed in 10 ml THF. The solvent was evaporated for 1 hour while the mixture was sonicated and stirred. The dried resulting product was heat-treated at 900° C. in a nitrogen atmosphere to obtain a silicon oxide coated with a carbonaceous material.

### Example 3

A 1.05 g piece of a 0.08 mm thick Li film and 30 ml of tetrahydrofuran (THF) were added to a 100 ml flask and mixed. The mixture was placed in an ice bath. Then, 5 cc of trichlorosilane (HSiCl₃, Aldrich) was added to the flask and the mixture was reacted for 24 hours. 10 ml of ethanol was slowly added to the mixture and reacted for 3 hours. The resulting product was filtered using a 0.5 μm filter, washed sequentially with ethanol, distilled water and acetone, and dried in an oven at 60° C. to obtain a partially oxidized silicon oxide precursor. Then, 0.2 g of the silicon oxide precursor and 0.08 g of pitch were mixed in 10 ml of THF. The solvent was evaporated for 1 hour while the mixture was sonicated and stirred. The dried resulting product was heat-treated at 900° C. in a nitrogen atmosphere to obtain a silicon oxide coated with a carbonaceous material.

### Example 4

A 1.07 g piece of a 0.08 mm thick Li film and 30 ml of tetrahydrofuran (THF) were added to a 100 ml flask and mixed. The mixture was placed in an ice bath. Then, 5.5 cc of tetrachlorosilane (SiCl₄, Aldrich) was added to the flask and the mixture was reacted for 24 hours. 10 ml of ethanol was slowly added to the mixture and reacted for 3 hours. The resulting product was filtered using a 0.5 μm filter, washed sequentially with ethanol, distilled water and acetone, and dried in an oven at 60° C. to obtain a partially oxidized silicon oxide precursor. Then, 0.2 g of the silicon oxide precursor and 0.08 g of pitch were mixed in 10 ml of THF. The solvent was evaporated for 1 hour while the mixture was sonicated and stirred. The dried resulting product was heat-treated at 900° C. in a nitrogen atmosphere to obtain a silicon oxide coated with a carbonaceous material.

### Comparative Example 1

Si particles (Aldrich) having a mean diameter of 43 μm were used.

### Comparative Example 2

Si particles (Nanostructured & Amorphous Materials, Inc., U.S.A.) having a mean diameter of 100 nm were used.

### Comparative Example 3

SiO (Pure Chemical, Co., Ltd., Japan) was used.

### Comparative Example 4

0.2 g of SiO particles (Pure Chemical, Co., Ltd., Japan) having a mean diameter of 2 μm and 0.08 g of pitch were mixed in 10 ml of THF. The solvent was evaporated for 1 hour while the mixture was sonicated and stirred. The dried resulting product was heat-treated at 900° C. in a nitrogen atmosphere to obtain a silicon oxide (SiO) coated with a carbonaceous material.

### Measurement of Energy Dispersive Spectrometer (EDS)

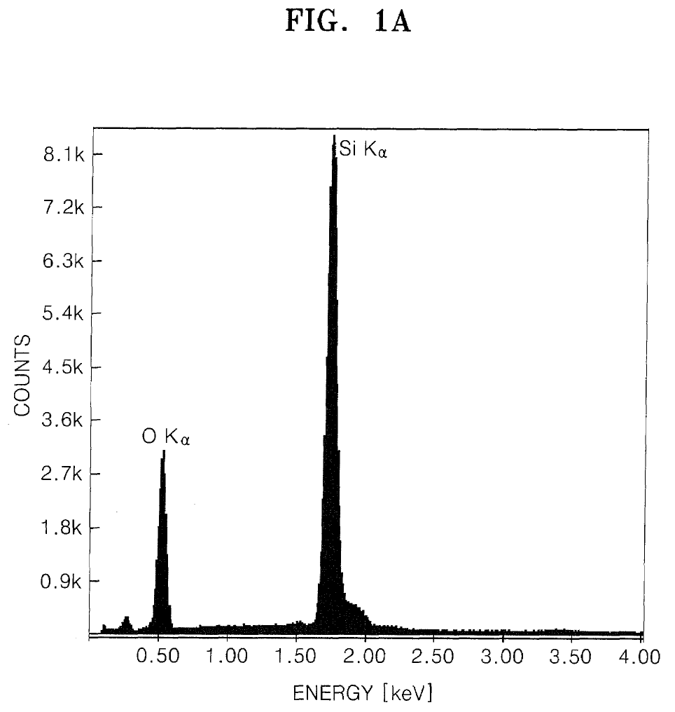

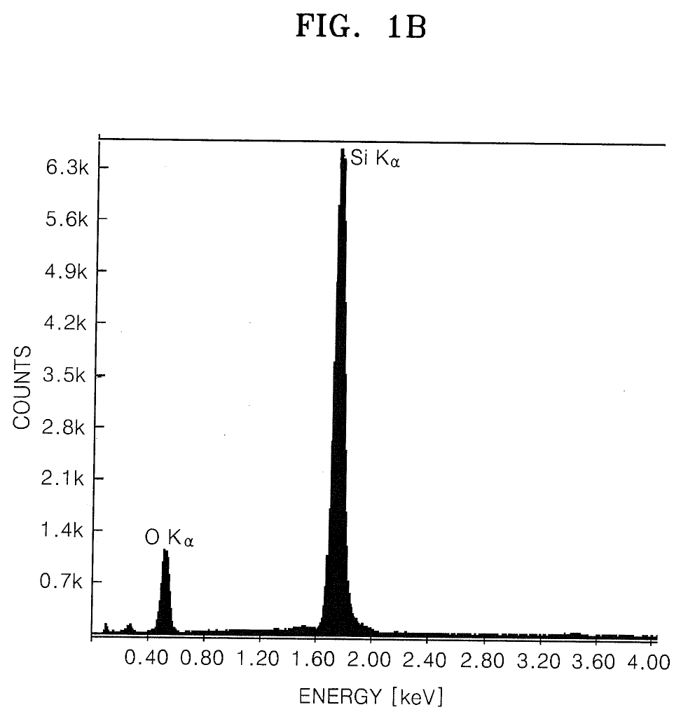

Energy dispersive spectrometer (EDS) measurements were taken of the silicon oxide prepared according to Example 1 and the SiO of Comparative Example 3, and the results are shown in FIGS. 1B and 1A, respectively. As illustrated in FIGS. 1A and 1B, the silicon oxide prepared according to Example 1 has an increased Si/O ratio compared to the silicon oxide (SiO) of Comparative Example 3. Accordingly, x is less than 1 in the silicon oxide (SiOₓ) prepared according to Example 1.

### Measurement of X-ray Diffraction (XRD)

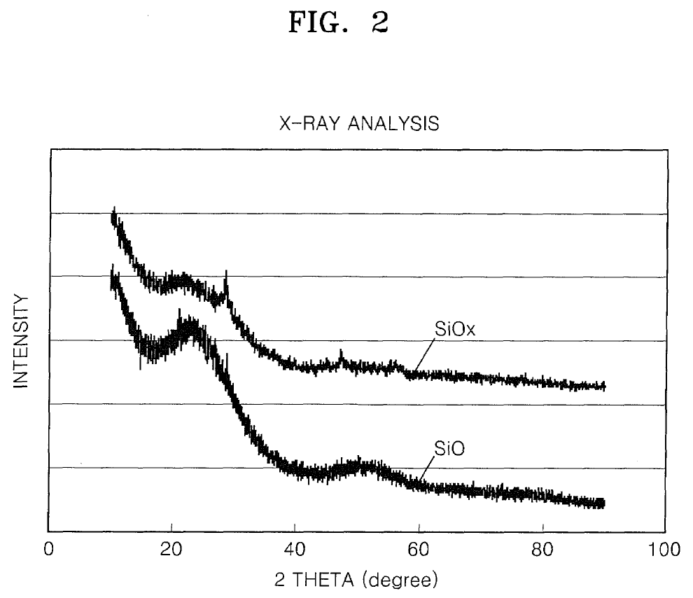

X-ray diffraction patterns were taken of the silicon oxide (SiOₓ) prepared according to Example 1 and the silicon oxide (SiO) of Comparative Example 3, and the results are shown in FIG. 2. As illustrated in FIG. 2, the silicon oxide prepared according to Example 1 shows a peak of silicon crystal, indicating that crystalline silicon is present.

### Measurement of Raman Spectrum

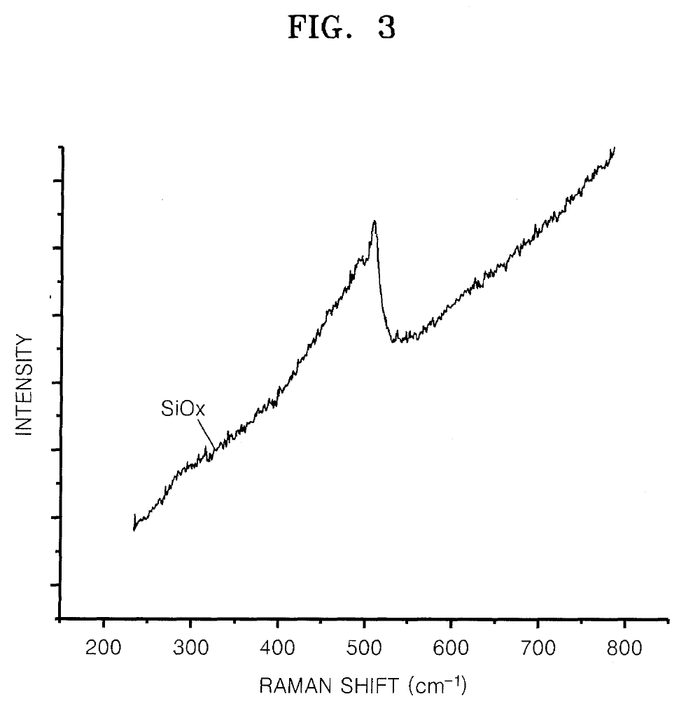

A raman spectrum was taken of the silicon oxide (SiOₓ) prepared according to Example 1, and the results are shown in FIG. 3. As illustrated in FIG. 3, the silicon oxide prepared according to Example 1 has a Raman shift in the vicinity of 500 cm⁻¹, and is thus considered to include amorphous silicon oxide. Therefore, the silicon oxide prepared according to Example 1 includes both crystalline and amorphous silicon oxides.

### PREPARATION OF ANODE

### Example 5

0.045 g of the silicon oxide prepared according to Example 1, 0.045 g of graphite (SFG-6, Timcal, Inc.), and 0.2 g of a solution of 5 wt % polyvinylidene fluoride (PVDF, Kureha Chemical Industry Corporation, Japan) in N-methylpyrrolidone (NMP) were mixed to prepare a slurry. The slurry was coated on Cu foil using a doctor blade to a thickness of about 50 μm. The resultant slurry coated Cu foil was dried in vacuum at 120° C. for 2 hours, and the resulting product was rolled to a thickness of 30 μm using a roller, thereby preparing an anode.

### Example 6

An anode was prepared as in Example 5, except that the slurry included 0.07 g of the silicon oxide prepared in Example 2, 0.015 g of carbon black (SuperP, Timcal, Inc.), and 0.3 g of a solution of 5 wt % polyvinylidene fluoride (PVDF, Kureha Chemical Industry Corporation, Japan) in N-methylpyrrolidone (NMP).

### Example 7

An anode was prepared as in Example 5, except that the slurry included 0.0585 g of the silicon oxide prepared according to Example 3, 0.0315 g of graphite (SFG6, Timcal, Inc.), and 0.2 g of a solution of 5 wt % polyvinylidene fluoride (PVDF, Kureha Chemical Industry Corporation, Japan) in N-methylpyrrolidone (NMP).

### Example 8

An anode was prepared as in Example 5, except that the slurry included 0.0585 g of the silicon oxide prepared in Example 4, 0.0315 g of graphite (SFG6, Timcal, Inc.), and 0.2 g of a solution of 5 wt % polyvinylidene fluoride (PVDF, Kureha Chemical Industry Corporation, Japan) in N-methylpyrrolidone (NMP).

### Comparative Example 5

An anode was prepared as in Example 5, except that the slurry included 0.027 g of the silicon oxide of Comparative Example 1, 0.063 g of graphite (SFG6, Timcal, Inc.), and 0.2 g of a solution of 5 wt % polyvinylidene fluoride (PVDF, Kureha Chemical Industry Corporation, Japan) in N-methylpyrrolidone (NMP).

### Comparative Example 6

An anode was prepared as in Example 5, except that the slurry included 0.027 g of the silicon oxide of Comparative Example 2, 0.063 g of graphite (SFG6, Timcal, Inc.), and 0.2 g of a solution of 5 wt % polyvinylidene fluoride (PVDF, Kureha Chemical Industry Corporation, Japan) in N-methylpyrrolidone (NMP).

### Comparative Example 7

An anode was prepared as in Example 5, except that the slurry included 0.07 g of the SiO prepared according to Comparative Example 4, 0.015 g of carbon black (SuperP, Timcal, Inc.), and 0.3 g of a solution of 5 wt % polyvinylidene fluoride (PVDF, Kureha Chemical Industry Corporation, Japan) in N-methylpyrrolidone (NMP).

### PREPARATION OF LITHIUM BATTERY

### Example 9

A CR2016-standard coin cell was prepared using the anode plate prepared according to Example 5, a lithium metal counter electrode, a polypropylene separator (Cellgard 3510), and an electrolyte solution including 1.3 M LiPF₆ dissolved in a mixture of ethylene carbonate (EC) and diethyl carbonate (DEC) (3:7 volume ratio).

### Example 10

A coin cell was prepared as in Example 9, except that the anode plate prepared according to Example 6 was used.

### Comparative Example 8

A coin cell was prepared as in Example 9, except that the anode plate prepared according to Comparative Example 5 was used.

### Comparative Example 9

A coin cell was prepared as in Example 9, except that the anode plate prepared according to Comparative Example 6 was used.

### Comparative Example 10

A coin cell was prepared as in Example 9, except that the anode plate prepared according to Comparative Example 7 was used.

### Example 11

A CR2016-standard coin cell was prepared using the anode plate prepared according to Example 7, a lithium metal counter electrode, a polypropylene separator (Celigard 3510), and an electrolyte solution including 1.3 M LiPF₆ dissolved in a mixture of EC, DEC and fluoroethylene carbonate (FEC) (2:6:2 volume ratio).

### Example 12

A coin cell was prepared as in Example 11, except that the anode plate prepared according to Example 8 was used.

### Charge-Discharge Tests

The coin cells prepared according to Examples 9 and 10 and Comparative Examples 8 through 10 were charged with a constant current of 100 mA with respect to 1 g of anode active materials to a cut-off voltage of 0.001 V (vs. Li). After a 10 minute rest time, the charged cells were discharged with a constant current of 100 mA with respect to 1 g of anode active material until an endpoint voltage of 1.5 V was reached, thereby obtaining a discharge capacity. The charge-discharge tests were repeated for 50 cycles.

Meanwhile, the coin cells prepared according to Examples 11 and 12 were charged with a constant current of 100 mA with respect to 1 g of anode active material to a cut-off voltage of 0.001 V (vs. Li). Then, a constant voltage charge was performed to a current of 10 mA with respect to 1 g of anode active materials while maintaining the 0.001 V potential. After a 10 minute rest time, the charged cells were discharged with a constant current of 100 mA with respect to 1 g of anode active material until an endpoint voltage of 1.5 V was reached, thereby obtaining a discharge capacity. The charge-discharge tests were repeated for 50 cycles.

The discharge capacity at each cycle was measured and capacity retention was calculated using the measured discharge capacity. The capacity retention was calculated using Equation 1 below, and the charge-discharge efficiency of the 1^{st} cycle was calculated using Equation 2 below.

Capacity retention (%)=50^{th} cycle discharge capacity/1^{st} cycle discharge capacity×100 Equation 1

1^{st} cycle charge-discharge efficiency (%)=1^{st} cycle discharge capacity/1^{st} cycle charge capacity×100 Equation 2

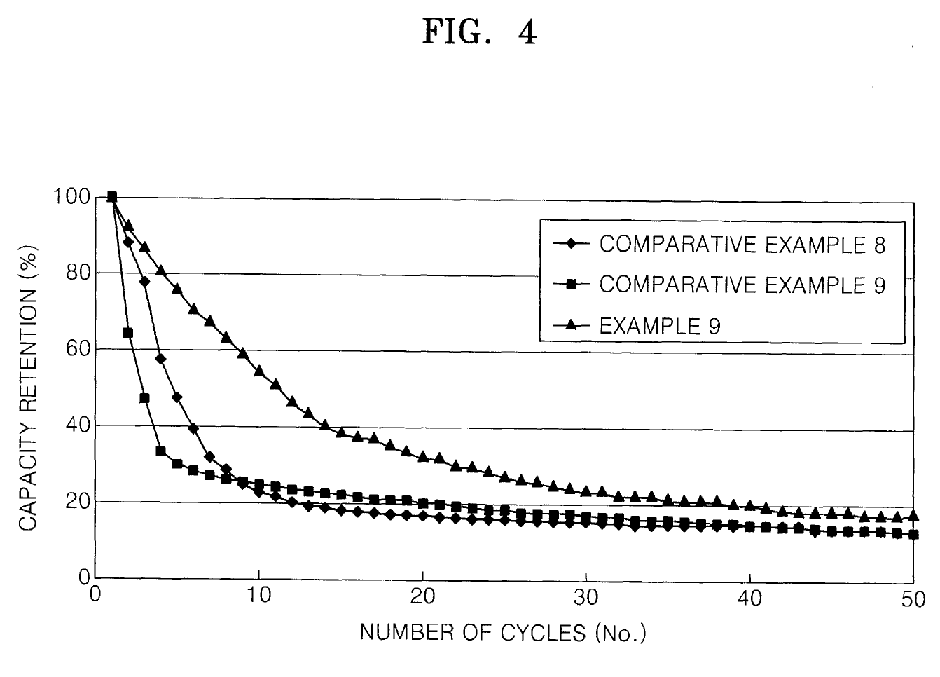

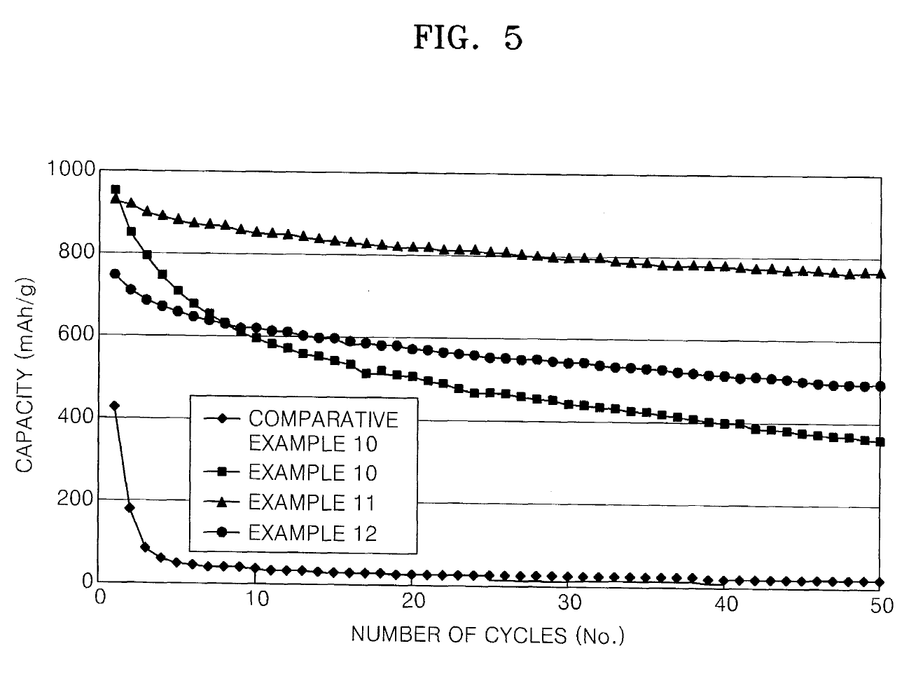

The results of the charge-discharge cycle tests for the coin cells prepared according to Example 9 and Comparative Examples 8 and 9 are shown in FIG. 4. The results of the charge-discharge cycle tests for the coin cells prepared according to Examples 10 through 12 and Comparative Example 10 are shown in Table 1 and FIG. 5.

TABLE 1

| | 1^{st} cycle discharge | 1^{st} cycle | Capacity |
|---|---|---|---|
| Lithium | capacity | charge-discharge | retention |
| battery | (mAh/g) | efficiency (%) | (%) |
| Example 10 | 951 | 51 | 38 |
| Example 11 | 935 | 69 | 82 |
| Example 12 | 745 | 60 | 67 |
| Comparative | 427 | 22 | 6 |
| Example 10 | | | |

As shown in Table 1, and FIGS. 4 and 5, the silicon oxide prepared according to Example 9 showed improved cycle life characteristics compared to the conventional silicon particles of Comparative Examples 8 and 9. The silicon oxides prepared according to Examples 10 through 12 showed improved initial discharge capacity compared to the conventional SiO of Comparative Example 10.

These results indicate that the cycle life characteristics of batteries can be noticeably improved. It is believed that such improvement is caused by increases in electrical capacity due to the high silicon content in the inventive silicon oxides. The inventive silicon oxides have low oxygen content (as shown in EDS graphs of FIGS. 1A and 1B). Since oxygen atoms function as support against the shrinkage/expansion of silicon atoms, electrical disconnections due to the shrinkage/expansion of silicon atoms are prevented.

In addition, it is believed that the carbonaceous material formed with the silicon oxide further improves electrical conductivity.

In addition, methods of preparing conventional silicon oxides include sintering at high temperatures of 1200° C. or higher and rapid cooling. In contrast, the silicon oxides of the present invention can be simply prepared by sintering a precursor obtained through a wet process in an inert atmosphere.

The anode active materials of the present invention are composite anode active materials including silicon oxides having low oxygen contents. Anodes and lithium batteries employing such composite anode active materials have excellent charge-discharge characteristics.

While the present invention has been illustrated and described with reference to certain exemplary embodiments, it is understood by those of ordinary skill in the art that various modifications and changes may be made to the described embodiments without departing from the spirit and scope of the present invention as defined by the following claims.

What is claimed is:

1. A silicon oxide based anode active material comprising a silicon oxide represented by the general formula SiOₓ, wherein 0<x<0.8.

2. The silicon oxide based anode active material of claim 1, wherein 0<x<0.5.

3. The silicon oxide based anode active material of claim 1, further comprising a material selected from the group consisting of metals capable of alloying with lithium, metal oxides capable of alloying with lithium, carbonaceous materials, and combinations thereof.

4. The silicon oxide based anode active material of claim 1, further comprising a material selected from the group consisting of Si, SiOₓ wherein 0.8<x≦2, Sn, SnOₓ wherein 0<x≦2, Ge, GeOₓ wherein 0<x≦2, Pb, PbOₓ wherein 0<x≦2, Ag, Mg, Zn, ZnOₓ wherein 0<x≦2, Ga, In, Sb, Bi, alloys thereof, and mixtures thereof.

5. The silicon oxide based anode active material of claim 3, wherein the carbonaceous material is selected from the group consisting of graphite, carbon black, carbon nanotubes, and mixtures thereof.

6. The silicon oxide based anode active material of claim 1, further comprising a carbonaceous coating layer on the silicon oxide.

7. An anode comprising the silicon oxide based anode active material of claim 1.

8. A lithium battery comprising an anode comprising the silicon oxide based anode active material of claim 1.

9. A method of preparing a silicon oxide based anode active material, the method comprising:
reacting a silane compound represented by Formula 1 with lithium to prepare a silicon oxide precursor; and
sintering the silicon oxide precursor in an inert atmosphere at a temperature ranging from about 400 to about 1300° C.:
SiXₙY₄₋ₙ Formula 1
wherein:
n is an integer ranging from 2 to 4,
X is a halogen atom, and
Y is selected from the group consisting of hydrogen atoms, phenyl groups and C₁₋₁₀ alkoxy groups.

10. The method of claim 9, wherein the sintering the silicon oxide precursor further comprises adding a carbonaceous material or carbon precursor to the silicon oxide precursor, wherein the carbonaceous material or carbon precursor is present in the silicon oxide precursor in an amount ranging from about 3 to about 90 wt % based on a total weight of the silicon oxide precursor and the carbonaceous material or carbon precursor.

11. The method of claim 10, wherein the carbonaceous material is selected from the group consisting of graphite, carbon black, carbon nanotubes, and mixtures thereof.

12. The method of claim 10, wherein the carbon precursor is selected from the group consisting of pitch, furfuryl alcohol, glucose, sucrose, phenol resins, phenol oligomers, resorcinol resins, resorcinol oligomers, phloroglucinol resins, phloroglucinol oligomers, and mixtures thereof.

13. The method of claim 9, wherein the sintering the silicon oxide precursor further comprises adding to the silicon oxide precursor a material selected from the group consisting of metals capable of alloying with lithium, metal oxides capable of alloying with lithium and mixtures thereof.

14. The method of claim 9, wherein the sintering the silicon oxide precursor further comprises adding to the silicon oxide precursor a material selected from the group consisting of Si, SiOₓ wherein 0.8<x≦2, Sn, SnOₓ wherein 0<x≦2, Ge, GeOₓ wherein 0<x≦2, Pb, PbOₓ wherein 0<x≦2, Ag, Mg, Zn, ZnOₓ wherein 0<x≦2, Ga, In, Sb, Bi, alloys thereof, and mixtures thereof.

15. The method of claim 9, wherein the silicon oxide precursor comprises an oxygen atom.

16. The method of claim 9, further comprising a second sintering after the sintering of the silicon oxide precursor, wherein the second sintering comprises sintering the silicon oxide precursor with a carbon precursor.

17. A method of preparing a silicon oxide based anode active material, the method comprising:
performing a gas phase reduction of a silane compound represented by Formula 1 to prepare a silicon oxide precursor; and
sintering the silicon oxide precursor in an inert atmosphere at a temperature ranging from about 400 to about 1300° C.:
SiXₙY₄₋ₙ Formula 1
wherein:
n is an integer ranging from 2 to 4,
X is a halogen atom, and
Y is selected from the group consisting of hydrogen atoms, phenyl groups and C₁₋₁₀ alkoxy groups.

18. The method of claim 17, wherein the sintering the silicon oxide precursor further comprises adding a carbonaceous material or carbon precursor to the silicon oxide precursor, wherein the carbonaceous material or carbon precursor is present in the silicon oxide precursor in an amount ranging from about 3 to about 90 wt % based on a total weight of the silicon oxide precursor and the carbonaceous material or carbon precursor.

19. The method of claim 17, wherein the sintering the silicon oxide precursor further comprises adding to the silicon oxide precursor a material selected from the group consisting of metals capable of alloying with lithium, metal oxides capable of alloying with lithium and mixtures thereof.

20. The method of claim 17, further comprising a second sintering after the sintering of the silicon oxide precursor, wherein the second sintering comprises sintering the silicon oxide precursor with a carbon precursor.
